(19) United States
(12) Patent Application Publication
(10) Pub. No.: US 2008/0066503 A1
(43) Pub. Date: Mar. 20, 2008

(54) Double lock that is opened forcibly

(76) Inventor: Shun-Chang Su, Changhua Hsien (TW)

Correspondence Address: Steven Horowitz;Counselor At Law, Suite 700, 295 Madison Avenue, New York, NY, 10017, US

(21) Appl. No.: 11/522,010

(22) Filed: Sep. 15, 2006

(51) Int. Cl. E05B 73/00

(52) U.S. Cl. 70/58

(57) ABSTRACT

A double lock includes a base, a top cover, two snapping members, a locking seat, a movable jacket, a slide, a number lock core, and a key lock core. Thus, the double lock is locked and unlocked by the number lock core and the key lock core, so that a user can lock and unlock the number lock core to open and close the double lock, and the inspector of the customs can use a specific key to lock and unlock the key lock core to open and close the double lock, thereby facilitating the user and the inspector of the customs operating the double lock.

### FIELD OF THE INVENTION

The present invention relates to a double lock and, more particularly, to a double lock for a luggage.

### BACKGROUND OF THE INVENTION AND DESCRIPTION OF THE PRIOR ART

A conventional lock for a luggage comprises a lock body, and a bonding strap mounted around the luggage and having a first end secured to a first end of the lock body and a second end detachably attached to a second end of the lock body. However, when the luggage is checked by an inspector of the customs, the inspector cannot unlock the lock to open the luggage if the user is absent, so that the inspector has to forcibly break the lock for checking the luggage, thereby causing inconvenience to the user and the inspector.

### BRIEF SUMMARY OF THE INVENTION

A double lock includes a base, a top cover, two snapping members, a locking seat, a movable jacket, a slide, a number lock core, and a key lock core. Thus, the double lock is locked and unlocked by the number lock core and the key lock core, so that a user can lock and unlock the number lock core to open and close the double lock, and the inspector of the customs can use a specific key to lock and unlock the key lock core to open and close the double lock, thereby facilitating the user and the inspector of the customs operating the double lock.

### IMPORTANT OBJECTS AND ADVANTAGES

The primary objective of the present invention is to provide a double lock for a luggage, wherein the double lock is opened forcibly by a person, such as an inspector of the customs, so as to check the luggage.

Another objective of the present invention is to provide a double lock that is locked and unlocked by the number lock core and the key lock core, so that a user can lock and unlock the number lock core to open and close the double lock, and the inspector of the customs can use a specific key to lock and unlock the key lock core to open and close the double lock, thereby facilitating the user and the inspector of the customs operating the double lock.

A further objective of the present invention is to provide a double lock, wherein the specified key is held by the inspector of the customs, so that the inspector can directly unlock the key lock core of the double lock by the specified key so as to open and check the luggage locked by the double lock without having to break the double lock for checking the luggage.

Further benefits and advantages of the present invention will become apparent after a careful reading of the detailed description with appropriate reference to the accompanying drawings.

### BRIEF DESCRIPTION OF THE DRAWING(S)

FIG. 1 is a perspective view of a double lock in accordance with the preferred embodiment of the present invention.

FIG. 2 is an exploded perspective view of the double lock as shown in FIG. 1.

FIG. 3 is a perspective view of a movable jacket of the double lock as shown in FIG. 2.

FIG. 4 is a perspective view of a top cover of the double lock as shown in FIG. 2.

FIG. 5 is a top plan cross-sectional view of the double lock as shown in FIG. 1.

FIG. 6 is a schematic operational view of the double lock as shown in FIG. 5.

FIG. 7 is a top plan cross-sectional view of the double lock as shown in FIG. 1.

FIG. 8 is a schematic operational view of the double lock as shown in FIG. 7.

FIG. 9 is a front plan cross-sectional view of the double lock as shown in FIG. 1.

FIG. 10 is a schematic operational view of the double lock as shown in FIG. 9.

FIG. 11 is a perspective view of the double lock for a luggage in accordance with the preferred embodiment of the present invention.

### DETAILED DESCRIPTION OF THE PREFERRED EMBODIMENT

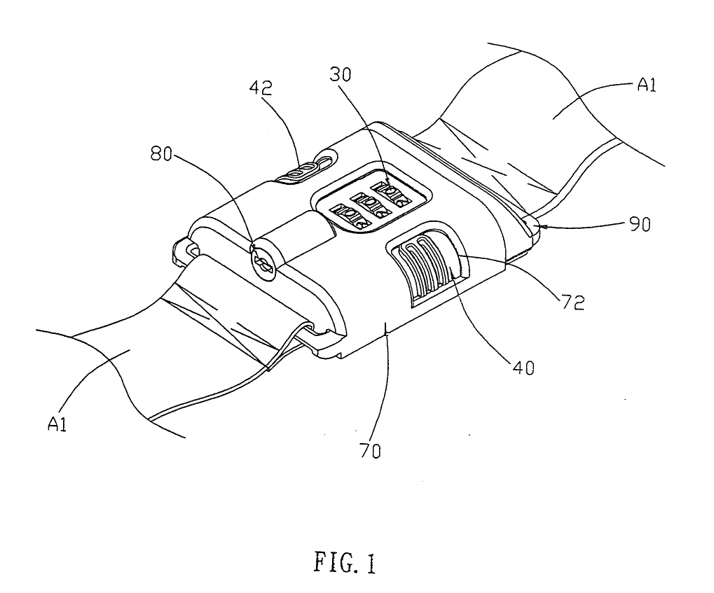

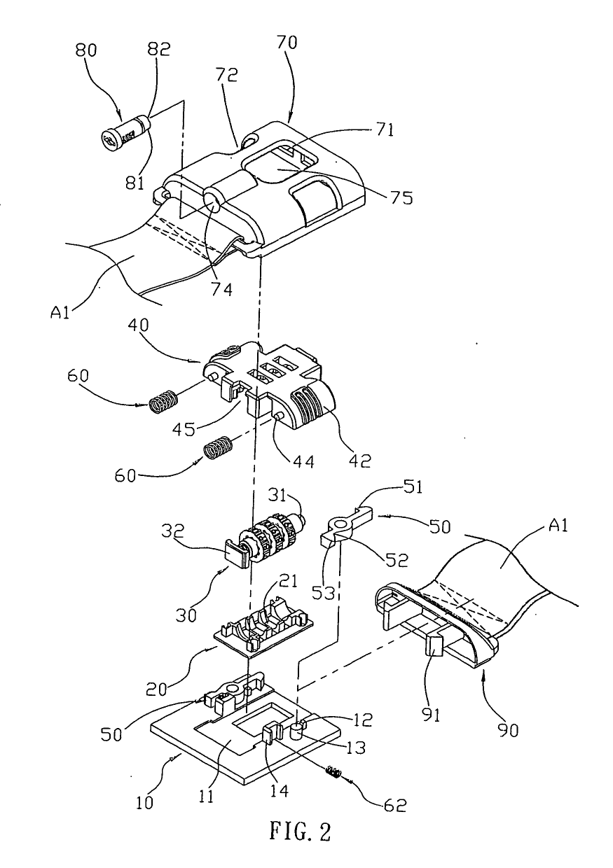

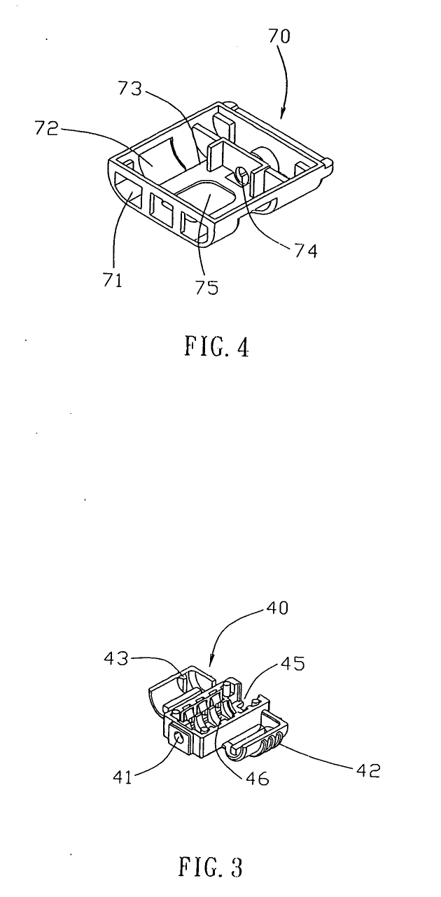

Referring to the drawings and initially to FIGS. 1-4, a double lock in accordance with the preferred embodiment of the present invention comprises a base 10 having a slideway 11, a top cover 70 combined with the base 10, two snapping members 50 each pivotally mounted on the base 10 and each having a first end formed with a press portion 53 and a second end formed with a snapping portion 51, a locking seat 90 detachably attached to the top cover 70 and provided with two locking portions 91 each extended through the top cover 70 and each detachably locked onto the snapping portion 51 of the respective snapping member 50, a movable jacket 40 movably mounted on the base 10 and having an inner wall provided with two press edges 43 each movable to press the press portion 53 of the respective snapping member 50 to pivot the respective snapping member 50 to detach the snapping portion 51 of the respective snapping member 50 from the respective locking portion 91 of the locking seat 90, a slide 20 slidably mounted in the slideway 11 of the base 10 and combined with the movable jacket 40, a number lock core 30 mounted between the movable jacket 40 and the slide 20 and having a first end provided with a spring-biased control plate 32, and a key lock core 80 mounted on the top cover 70 and rested on the control plate 32 of the number lock core 30.

The base 10 has two sides provided with two mounting posts 13, two receiving seats 14 and two limit blocks 12. Each of the limit blocks 12 of the base 10 is rested on the second end of the respective snapping member 50 to limit pivotal movement of the respective snapping member 50. The slideway 11 of the base 10 is located between the snapping members 50.

The top cover 70 has an inside formed with a receiving chamber 73 to receive the movable jacket 40. The top cover 70 has a first end formed with two passages 71 connected to the receiving chamber 73 to allow passage of the locking portions 91 of the locking seat 90 and a second end formed with a receiving recess 74 connected to the receiving chamber 73 to receive the key lock core 80. The top cover 70 has two sides formed with two finger holes 72 respectively connected to the receiving chamber 73.

The slide 20 has an inside formed with a receiving chamber 21 to receive the number lock core 30.

The number lock core 30 has a second end provided with a stop flange 31.

The movable jacket 40 has an outer wall provided with two serrated push portions 42 each exposed from the respective finger hole 72 of the top cover 70. The movable jacket 40 has an inside formed with a receiving chamber 46 to receive the number lock core 30. The receiving chamber 46 of the movable jacket 40 has a first end formed with a receiving recess 45 to receive the control plate 32 of the number lock core 30 and a second end formed with a limit hole 41 to receive the stop flange 31 of the number lock core 30. The movable jacket 40 has a side formed with two mounting stubs 44.

Each of the snapping members 50 has a mediate portion located between the snapping portion 51 and the press portion 53 and pivotally mounted on the respective mounting post 13 of the base 10. The first end of each of the snapping members 50 is formed with a concave portion 52 located beside the press portion 53 to receive the respective press edge 43 of the movable jacket 40. The snapping portion 51 and the press portion 53 of each of the snapping members 50 are directed toward two different directions.

The double lock further comprises two elastic members 60 each biased between the top cover 70 and the movable jacket 40 to push the movable jacket 40, so that each of the push portions 42 of the movable jacket 40 is movable to align with the respective finger hole 72 of the top cover 70, and each of the press edges 43 of the movable jacket 40 is movable to slide into the concave portion 52 of the respective snapping member 50. Each of the two elastic members 60 has an end mounted on the respective mounting stub 44 of the movable jacket 40.

The double lock further comprises two elastic members 62 each biased between the base 10 and the first end of the respective snapping member 50 to push the press portion 53 of the respective snapping member 50 toward the respective press edge 43 of the movable jacket 40 and to push the second end of the respective snapping member 50 to rest on the respective limit block 12 of the base 10. Each of the two elastic members 62 is mounted in the respective receiving seat 14 of the base 10.

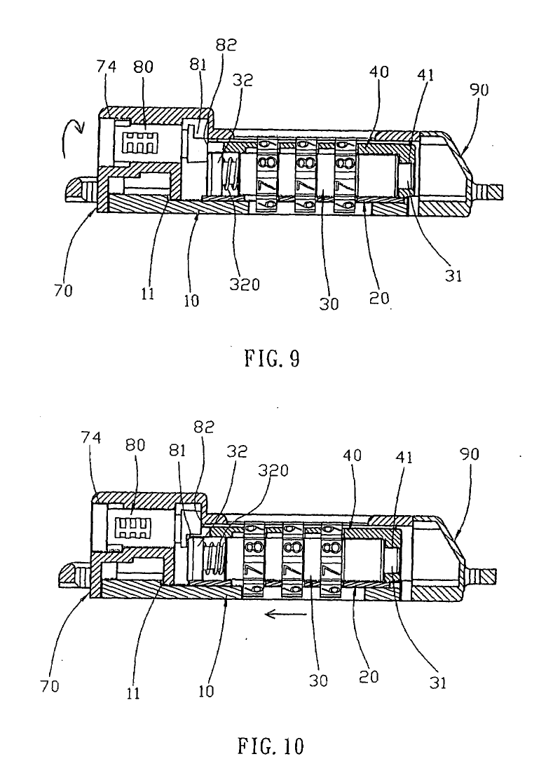

The key lock core 80 is extended through the receiving recess 74 of the top cover 70 into the receiving recess 45 of the movable jacket 40 to rest on the control plate 32 of the number lock core 30. The key lock core 80 has an end portion 82 (see FIG. 9) rested on the control plate 32 of the number lock core 30 and formed with a cutout 81 that is movable to align with the control plate 32 of the number lock core 30 by rotation of the key lock core 80.

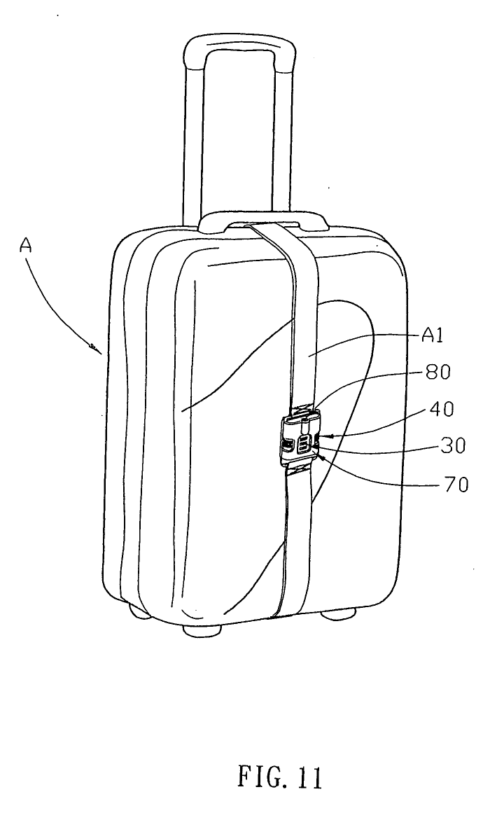

As shown in FIGS. 1, 2 and 11, a bonding strap “A1” is mounted around a luggage “A” and attached to the double lock. The bonding strap “A1” has a first end attached to the second end of the top cover 70 and a second end attached to the locking seat 90. Thus, when the number lock core 30 and the key lock core 80 are locked, each of the snapping members 50 is locked by the respective press edge 43 of the movable jacket 40 and the respective limit block 12 of the base 10, so that each of the locking portions 91 of the locking seat 90 is locked by the snapping portion 51 of the respective snapping member 50 to lock the locking seat 90 onto the base 10, thereby locking the luggage “A” by the double lock.

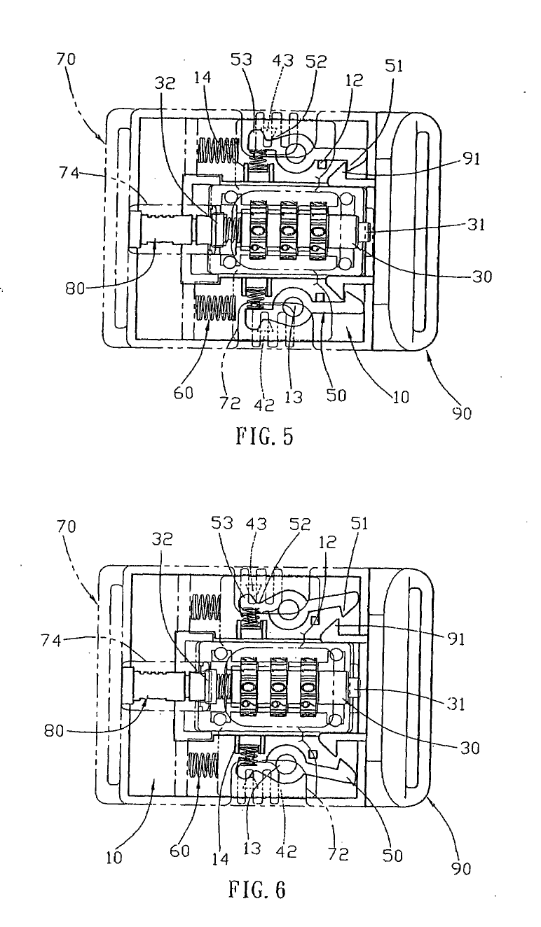

As shown in FIGS. 1, 2 and 5, when the number lock core 30 is locked, the number lock core 30 is disposed at a fixed state, and each of the snapping members 50 is locked by the respective press edge 43 of the movable jacket 40 and the respective limit block 12 of the base 10, so that each of the locking portions 91 of the locking seat 90 is locked by the snapping portion 51 of the respective snapping member 50 to lock the locking seat 90 onto the base 10.

As shown in FIGS. 1, 2 and 6, when the number lock core 30 is unlocked, the number lock core 30 is disposed at a movable state, so that the movable jacket 40 and the slide 20 are movable relative to the base 10. In such a manner, when the push portions 42 of the movable jacket 40 are moved leftward (or backward) by a user's fingers as shown in FIG. 6, each of the press edges 43 of the movable jacket 40 is moved to detach from the concave portion 52 of the respective snapping member 50 and to press the press portion 53 of the respective snapping member 50 to pivot the respective snapping member 50 to move and detach the snapping portion 51 of the respective snapping member 50 from the respective locking portion 91 of the locking seat 90 to unlock the locking seat 90, so that the locking seat 90 can be detached from the base 10, thereby unlocking the luggage “A”.

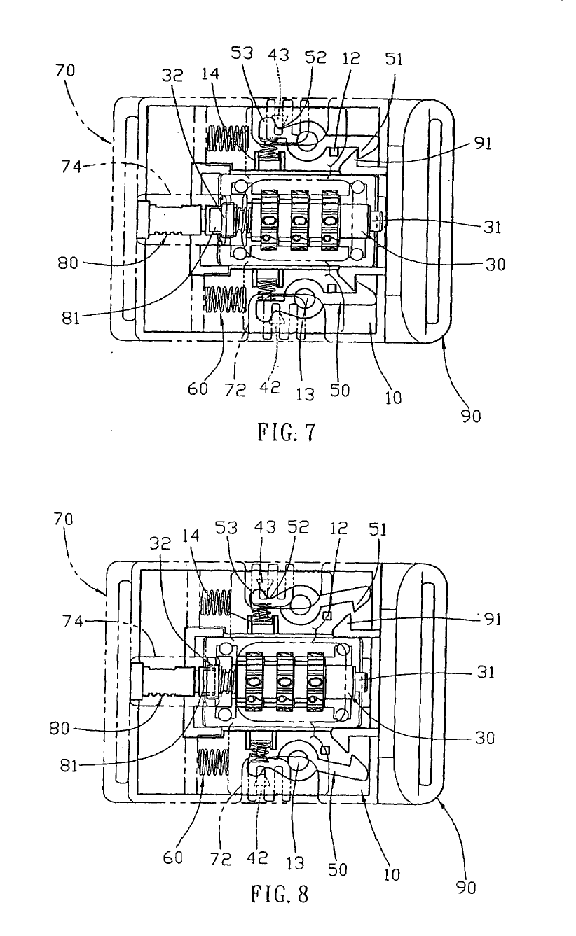

As shown in FIGS. 1, 2 and 7, when the key lock core 80 is locked, each of the snapping members 50 is locked by the respective press edge 43 of the movable jacket 40 and the respective limit block 12 of the base 10, so that each of the locking portions 91 of the locking seat 90 is locked by the snapping portion 51 of the respective snapping member 50 to lock the locking seat 90 onto the base 10.

At this time, as shown in FIG. 9, the end portion 82 of the key lock core 80 is rested on the control plate 32 of the number lock core 30 to retain the number lock core 30.

As shown in FIG. 10, when the key lock core 80 is rotated by a specific key (not shown), the cutout 81 of the key lock core 80 is movable to align with the control plate 32 of the number lock core 30 by rotation of the key lock core 80 to release the control plate 32 of the number lock core 30, so that the control plate 32 of the number lock core 30 is movable leftward (or backward) by the restoring force of a spring 320 of the number lock core 30. Thus, the control plate 32 is distant from the number lock core 30, so that the number lock core 30 is disposed at a movable state, and the movable jacket 40 and the slide 20 are movable relative to the base 10.

As shown in FIGS. 1, 2 and 8, when the push portions 42 of the movable jacket 40 are moved leftward (or backward) by an inspector's fingers of the customs as shown in FIG. 8, each of the press edges 43 of the movable jacket 40 is moved to detach from the concave portion 52 of the respective snapping member 50 and to press the press portion 53 of the respective snapping member 50 to pivot the respective snapping member 50 to move and detach the snapping portion 51 of the respective snapping member 50 from the respective locking portion 91 of the locking seat 90 to unlock the locking seat 90, so that the locking seat 90 can be detached from the base 10, thereby unlocking the luggage “A”.

Accordingly, the double lock is locked and unlocked by the number lock core 30 and the key lock core 80, so that a user can lock and unlock the number lock core 30 to open and close the double lock, and the inspector of the customs can use a specific key to lock and unlock the key lock core 80 to open and close the double lock, thereby facilitating the user and the inspector of the customs operating the double lock. In addition, the specified key is held by the inspector of the customs, so that the inspector can directly unlock the key lock core 80 of the double lock by the specified key so as to open and check the luggage locked by the double lock without having to break the double lock for checking the luggage.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A double lock, comprising:
a base having a slideway;
a top cover combined with the base;
two snapping members each pivotally mounted on the base and each having a first end formed with a press portion and a second end formed with a snapping portion;
a locking seat detachably attached to the top cover and provided with two locking portions each extended through the top cover and each detachably locked onto the snapping portion of the respective snapping member;
a movable jacket movably mounted on the base and having an inner wall provided with two press edges each movable to press the press portion of the respective snapping member to pivot the respective snapping member to detach the snapping portion of the respective snapping member from the respective locking portion of the locking seat;
a slide slidably mounted in the slideway of the base and combined with the movable jacket;
a number lock core mounted between the movable jacket and the slide and having a first end provided with a spring-biased control plate;
a key lock core mounted on the top cover and rested on the control plate of the number lock core.

2. The double lock in accordance with claim 1, wherein the base has two sides provided with two limit blocks each rested on the second end of the respective snapping member to limit pivotal movement of the respective snapping member.

3. The double lock in accordance with claim 2, further comprising two elastic members each biased between the base and the first end of the respective snapping member to push the press portion of the respective snapping member toward the respective press edge of the movable jacket and to push the second end of the respective snapping member to rest on the respective limit block of the base.

4. The double lock in accordance with claim 3, wherein the base has two sides provided with two receiving seats, and each of the two elastic members is mounted in the respective receiving seat of the base.

5. The double lock in accordance with claim 1, wherein the slideway of the base is located between the snapping members.

6. The double lock in accordance with claim 1, wherein the slide has an inside formed with a receiving chamber to receive the number lock core.

7. The double lock in accordance with claim 1, wherein the base has two sides provided with two mounting posts, and each of the snapping members has a mediate portion located between the snapping portion and the press portion and pivotally mounted on the respective mounting post of the base.

8. The double lock in accordance with claim 1, wherein the first end of each of the snapping members is formed with a concave portion located beside the press portion to receive the respective press edge of the movable jacket.

9. The double lock in accordance with claim 1, wherein the snapping portion and the press portion of each of the snapping members are directed toward two different directions.

10. The double lock in accordance with claim 1, wherein the top cover has an inside formed with a receiving chamber to receive the movable jacket.

11. The double lock in accordance with claim 10, wherein the top cover has a first end formed with two passages connected to the receiving chamber to allow passage of the locking portions of the locking seat and a second end formed with a receiving recess connected to the receiving chamber to receive the key lock core.

12. The double lock in accordance with claim 8, wherein the top cover has two sides formed with two finger holes respectively, and the movable jacket has an outer wall provided with two serrated push portions each exposed from the respective finger hole of the top cover.

13. The double lock in accordance with claim 1, wherein the movable jacket has an inside formed with a receiving chamber to receive the number lock core.

14. The double lock in accordance with claim 13, wherein the receiving chamber of the movable jacket has a first end formed with a receiving recess to receive the control plate of the number lock core.

15. The double lock in accordance with claim 14, wherein the number lock core has a second end provided with a stop flange, and the receiving chamber of the movable jacket has a second end formed with a limit hole to receive the stop flange of the number lock core.

16. The double lock in accordance with claim 12, further comprising two elastic members each biased between the top cover and the movable jacket to push the movable jacket, so that each of the push portions of the movable jacket is movable to align with the respective finger hole of the top cover, and each of the press edges of the movable jacket is movable to slide into the concave portion of the respective snapping member.

17. The double lock in accordance with claim 16, wherein the movable jacket has a side formed with two mounting stubs, and each of the two elastic members has an end mounted on the respective mounting stub of the movable jacket.

18. The double lock in accordance with claim 14, wherein the key lock core is extended through a receiving recess of the top cover into the receiving recess of the movable jacket to rest on the control plate of the number lock core.

19. The double lock in accordance with claim 1, wherein the key lock core has an end portion rested on the control plate of the number lock core and formed with a cutout that is movable to align with the control plate of the number lock core by rotation of the key lock core.

20. The double lock in accordance with claim 1, wherein when the number lock core is unlocked, the number lock core is disposed at a movable state, so that the movable jacket and the slide are movable relative to the base.
